(19) United States
(12) Patent Application Publication
(10) Pub. No.: US 2026/0312340 A1
(43) Pub. Date: Oct. 8, 2026

(54) Support Sleeve, Pre-assembled Cable Containing the Support Sleeve, and Plug Connector Assembly Containing the Support Sleeve

(71) Applicant: ROSENBERGER HOCHFREQUENZTECHNIK GMBH & CO. KG, Fridolfing (DE)

(72) Inventor: Hubert Speckbacher, Muehldorf a. Inn (DE)

(21) Appl. No.: 19/638,444

(22) Filed: Apr. 3, 2026

(30) Foreign Application Priority Data
Apr. 4, 2025 (EP) 25168427.0

(51) Int. Cl. H01R 13/6592

(52) U.S. Cl. CPC H01R 13/6592

(57) ABSTRACT

A support sleeve for guiding and fixing at least one line, preferably at least one electrical line, has a main body which is designed in the form of a sleeve around a longitudinal axis (L_{A}) of the support sleeve, and at least one web-shaped region directed towards the longitudinal axis (L_{A}). A feedthrough is formed in the web-shaped region in such a way that each line is held in the feedthrough without movement.

### FIELD OF THE INVENTION

The present invention relates to a support sleeve for guiding and fixing at least one line, which has a sleeve-shaped main body.

The present invention also relates to a pre-assembled cable comprising at least one line, a shield surrounding the at least one line, and a cable sheath surrounding the shield. A support sleeve is fixed to a shield exposed by the cable sheath at the axial end region of the pre-assembled cable and/or to the cable sheath, and the shield is folded back around the fixed support sleeve.

Lastly, the invention also relates to a plug connector assembly comprising the pre-assembled cable and a plug connector connected to the pre-assembled cable. The plug connector has an outer conductor contact element which is pressed, preferably crimped, onto the axial end region of the shield folded back onto the support sleeve.

### TECHNICAL BACKGROUND

In a plug connector assembly consisting of a cable and an associated plug connector, a stable electrical and mechanical connection must be established between the cable and the plug connector. With regard to a stable mechanical connection, national and international standards require a certain holding force between the plug connector and the cable when longitudinal or transverse tension is applied to the cable.

Crimp connections have established themselves as a stable and quick connection technology for ensuring a secure electrical and mechanical connection between the plug connector and the cable. To optimize the crimp connection, a support sleeve is preferably used, which is pre-fixed in the case of an electrical plug connection on the shield exposed by the cable sheath and/or directly on the cable sheath, and in the case of an optical plug connection on the reinforcement layer exposed by the cable sheath. The axial end of the shield or reinforcement layer is usually folded back over the support sleeve. During the crimping process, the shield is clamped between the outer conductor contact element and the support sleeve in the case of an electrical plug connection, and the reinforcement layer is clamped between the plug connector housing and the support sleeve in the case of an optical plug connection, in each case by form-fit, frictional engagement, and/or integral bond. Duringinsuonductor the crimping process, a spring force is generated in the support sleeve by transferring the support sleeve from a mechanically relaxed basic state to an elastically preloaded state.

The spring force causes optimized clamping of the shield or the reinforcement layer of the cable to the plug connector.

EP 3 618 197 B1 describes a support sleeve for a differential electrical plug connector. To better match the cross-sectional contour of the support sleeve to the cross-sectional profile of the differential cable, two opposing U-shaped profiles are formed on the plug-in side of the support sleeve.

The support sleeve with the two U-shaped profiles on the plug-in side has the disadvantage of requiring considerable manufacturing and assembly effort.

This is a situation that needs to be improved.

### SUMMARY OF THE INVENTION

Against this background, the present invention addresses the problem of providing a support sleeve for a cable with at least one line, preferably for a cable with at least one line pair, which is simple and therefore inexpensive to manufacture and assemble.

According to the invention, this problem is solved by a support sleeve with the features of Claim 1, by a pre-assembled cable with the features of Claim 14, and by a plug connector assembly with the features of Claim 15.

Accordingly, the following is provided:

A support sleeve for guiding and fixing at least one line, preferably at least one electrical line, comprising
a main body,
which is designed in the form of a sleeve around a longitudinal axis of the support sleeve,
wherein at least one axial end of the sleeve-shaped main body has a web-shaped region directed to the longitudinal axis
with a feedthrough such that each line is held in the feedthrough without movement.

The insight/idea underlying the present invention is to create a support sleeve with a sleeve-shaped main body and with a web-shaped region at at least one axial end of the sleeve-shaped main body. The feedthrough of the respective web-shaped region is designed in such a way that each line is held in the feedthrough without movement.

In this way, a support sleeve is realized in which the fixation of preferably each line of the cable to the support sleeve is achieved by forming at least one axial end region or one axial end face of the support sleeve. In the preferred application of a cable with at least one line pair, the two lines of each line pair are aligned in a corresponding plane, which runs through the longitudinal axis of the support sleeve, by the shaping of at least one axial end region of the support sleeve. Since only the planar punched pattern of the support sleeve determines the shape of the feedthrough of the individual web-shaped region of the support sleeve, the size and shape of the feedthrough in the support sleeve can be adapted to the cable configuration used more easily and precisely than in the prior art. In contrast to the support sleeve of EP 3 618 197 B1, which can only be manufactured with a two-part crimping tool, the support sleeve according to the invention can be manufactured over its entire longitudinal extension with a single crimping tool. The design of the fixation or alignment of the individual lines at only at least one axial end of the support sleeve also reduces the amount of material required for the support sleeve.

The invention relates to a support sleeve for indirect or direct attachment to a cable, preferably an electrical cable. The invention is described below primarily for use with an electrical cable, but this should not be understood as a limitation, as the support sleeve may also be suitable for attachment to an optical cable, for example.

The invention relates to a support sleeve for indirect or direct attachment to an electrical cable, which preferably has at least one electrical line pair, each with two electrical lines for transmitting a differential electrical signal. The invention is described below primarily for use with an electrical cable having at least one electrical line pair, but this should not be understood as limiting. The support sleeve is also suitable for an electrical cable with an odd number of electrical lines, for example for a coaxial electrical cable with a single internal electrical line for transmitting an asymmetrical electrical signal, or for an electrical cable with three electrical lines for transmitting a three-phase alternating current. In particular, several electrical lines can be fixed and aligned in the support sleeve.

The support sleeve is preferably designed for the frictionally engaged, form-fitting, and/or integrally bonded fixing of an electrical shield of the cable. In particular, it may be provided that the shield can be fixed between the support sleeve and an outer conductor contact element mentioned below by means of a frictional engagement, form-fit and/or integral bond, in particular by clamping.

For the best possible clamping of the cable shield between the outer conductor contact element and the support sleeve, the support sleeve is designed to be substantially sleeve-shaped over its longitudinal extent, equivalent to the outer conductor contact element. The sleeve-shaped design of the support sleeve, in particular the sleeve-shaped design of the main body of the support sleeve, does not exclude interruptions in the sleeve-shaped support sleeve geometry, such as slots, holes, bores, notches, etc. The sleeve-shaped main body of the support sleeve substantially completely encloses the shield and the at least one electrical line pair enclosed by the shield along the longitudinal extension of the support sleeve.

The web-shaped region of the support sleeve formed at at least one axial end of the sleeve-shaped main body is directed toward the longitudinal axis of the support sleeve. In this way, the size of the feedthrough for the at least one electrical line pair in the region of the web-shaped regions is reduced compared to the other longitudinal portions of the sleeve-shaped main body. The clamping of the at least one electrical line pair within the support sleeve is thus limited to the region of the web-shaped regions of the support sleeve. The precision of the support sleeve can thus be limited to the feedthrough formed in the respective web-shaped region. The sleeve-shaped main body of the support sleeve can thus be manufactured with lower manufacturing precision and, for example, have a small longitudinal gap.

The web-shaped region at one axial end of the sleeve-shaped main body of the support sleeve is directed toward the longitudinal axis of the support sleeve, i.e., a longitudinal extension of the web-shaped region is directed toward the longitudinal axis of the support sleeve and thus toward the electrical lines of the at least one electrical line pair or toward the shield arranged between them. In each case, therefore, there is a web or web-shaped region formed on the inside of the sleeve-shaped main body.

The web-shaped regions and the sleeve-shaped main body of the support sleeve are preferably formed in one piece. However, it is not excluded that, in a less preferred embodiment of the support sleeve, the web-shaped regions and the main body of the support sleeve may be designed in several parts and may be suitably connected to each other.

The support sleeve is preferably made of copper, a copper alloy such as brass or copper bronze, steel, in particular spring steel, and in rarer cases of application, aluminum or a plastic, and in certain cases coated with a suitable coating material.

The web-shaped region is shaped in such a way that the electrical lines of each electrical line pair are held in the feedthrough of the web-shaped region without movement.

In order to hold the individual electrical lines in the feedthrough of the web-shaped regions of the support sleeve, in particular to hold them without movement, i.e., in a specific position relative to a longitudinal axis of the support sleeve, for example to the center axis of the support sleeve, each electrical line of each electrical line pair should preferably be supported in both directions (positive direction and negative direction) of the two directional dimensions, which are oriented perpendicular to the longitudinal axis of the support sleeve and perpendicular to each other.

If the electrical line is not supported by at least one other electrical line in one direction of at least one directional dimension, the individual electrical line should preferably be supported by a corresponding shaping of the feedthrough of the respective web-shaped region at the boundary of the feedthrough in the remaining directions of the respective remaining directional dimensions-preferably indirectly via the shield arranged between them. The support between the electrical line and the boundary of the feedthrough can, for example, be either linear or planar.

A linear support between the electrical line and the boundary or inner sheath of the feedthrough preferably extends in the direction of the longitudinal axis of the support sleeve. A flat support between the electrical line and the boundary or inner sheath of the feedthrough preferably extends in a specific inner sheath segment of the web-shaped region in the direction of the longitudinal axis and in the circumferential direction of the support sleeve. In particular in the event of a deformation of the cross-section of the electrical line as a result of a clamping in the feedthrough of the respective web-shaped region-but not exclusively in the case of deformation-there is a flat support between the boundary of the feedthrough and the electrical line.

In addition to holding or fixing the individual electrical line in the feedthrough of the respective web-shaped region of the support sleeve, the two electrical lines of an electrical line pair can be positioned in an associated imaginary plane within the feedthrough in which the longitudinal axis of the support sleeve lies. Thus, the two electrical lines of each electrical line pair can be aligned in a defined orientation within the plug connector for the cable assembly process.

Advantageous designs and developments result from the further dependent claims and from the description with reference to the figures in the drawing.

It is understood that the features mentioned above and those to be explained below can be used not only in the combination specified in each case, but also in other combinations or on their own, without departing from the scope of the present invention.

In a preferred development of the support sleeve according to the invention, the boundary of the feedthrough may have at least regions which are each shaped in such a way as to follow at least a portion of a surface contour of an adjacent electrical line of the electrical line pairs. In this way, the individual electrical line is supported over a large area on an adjacent portion of the inner wall of the web-shaped region.

The contour sequence of the boundary of the feedthrough, i.e., the inner wall of the web-shaped region, can extend over a limited circumferential portion of the cylindrical sheath of the electrical line, for example over a semi-cylindrical or a quarter-cylindrical or a three-quarter-cylindrical sheath portion of the electrical line. In an extreme embodiment, the inner wall of the web-shaped region can enclose the individual electrical line fully cylindrically and thus separate the individual electrical lines of the electrical line pairs approximately completely from each other. The values given as examples for a contour sequence show that the individual electrical line can be supported in at least one direction of two directional dimensions on the inner wall of the web-shaped region. In the other direction of the two directional dimensions, the individual electrical line can be supported on at least one other adjacent electrical line (the two directional dimensions are oriented orthogonally to each other). However, the latter is not mandatory, since an electrical line can be spaced apart from an adjacent electrical line by an air gap and still be held in place in both directional dimensions in the feedthrough of the web-shaped region.

In an alternative, preferred development of the support sleeve according to the invention, the feedthrough may have a rectangular profile, the side surfaces of which are each designed in such a way that they are connected at least linearly to at least one adjacent electrical line of the electrical line pairs. In this context, “being connected” means “being connected” at least indirectly between the electrical line and the associated side surfaces of the feedthrough formed in the web-shaped region via a shield arranged between them. The rectangular profile may have rounded corners or pronounced corners. The shield may consist of interwoven metal wires and/or a metallized plastic film.

Ideally, there should be no compression of the electrical lines by the web-shaped regions of the support sleeve, so that the side surfaces of the feedthrough are connected to the corresponding adjacent electrical lines in a linear fashion only. If the electrical lines are compressed by the web-shaped regions of the support sleeve, the side surfaces of the feedthrough can preferably be connected to the corresponding adjacent electrical lines in a flat manner.

While the geometries described above are useful for a feedthrough in a web-shaped region formed at the plug end of the support sleeve with regard to the correct alignment of the two electrical lines of an electrical line pair, a feedthrough in a web-shaped region formed at the cable end of the support sleeve may preferably have a round profile.

In this case, in the case of a cable with electrical lines twisted together, each individual electrical line can pass through the feedthrough of the cable-side web-shaped region of the support sleeve at a defined angle of rotation relative to the other electrical lines, but at any angle of rotation relative to an imaginary reference axis of the feedthrough. In addition, a web-shaped region formed at both axial ends of the support sleeve prevents the support sleeve from tilting disadvantageously relative to the electrical lines.

In a preferred embodiment of the support sleeve according to the invention, it is designed as a stamped and bent part.

The stamping and bending technique enables cost-effective production in high to very high volumes. In addition, the stamping and bending technique makes it possible to form the web-shaped regions of the support sleeve with the geometries described above for a feedthrough in the respective web-shaped region at a realistic cost.

The support sleeve manufactured using the stamping and bending technique has a longitudinal gap which is preferably closed or, at most, has a small to very small gap width. The sleeve-shaped main body of the support sleeve can preferably be mechanically stabilized by a form-fitting connection between the two side edges of the support sleeve. For this purpose, at least one recess is formed on one side edge, which can be fixed in place with a corresponding elevation formed on the other side edge. The elevation can, for example, be designed as a finger-shaped or puzzle-shaped elevation, which can engage with a finger-shaped or puzzle-shaped recess.

In a further preferred embodiment of the support sleeve according to the invention, the web-shaped region of the support sleeve can be designed as a flange. In this context and in the following, flanging is understood to mean bending an axial edge region of the support sleeve to form an inner web-shaped region. The flanging can preferably be carried out as part of the punching and bending process.

The axial edge regions of the planar punched shape belonging to the support sleeve can be suitably slotted in order to achieve web-shaped regions at the axial ends of the sleeve-shaped main body without bulges or material build-up in the bending process. Thus, at least one slit, preferably several equidistant slits, can be formed in each web-shaped region. The individual slit can preferably be closed. Due to manufacturing tolerances, the individual slit may also be slightly open.

If a cable with a single electrical line pair for transmitting a single differential signal is provided, the feedthrough through the web-shaped region of the support sleeve, in particular the plug-side web-shaped region of the support sleeve, can preferably be elliptical in shape. Consequently, in a further preferred development of the support sleeve according to the invention, a cross-section of the outer sheath of the support sleeve along a longitudinal extension of the main body may also be elliptical in shape. The installation space of a support sleeve shaped in this way is advantageously minimized.

In an alternative preferred development of the support sleeve according to the invention, a cross-section of the outer sheath of the support sleeve may be rounded along a longitudinal extension of the main body. In this case, the rounded outer sheath profile of the support sleeve is optimally adapted to a typically also rounded cross-sectional profile of the outer conductor contact element. The crimp connection, in which the shield is pressed or clamped between the round inner sheath profile of the outer conductor contact element and the round outer sheath profile of the support sleeve, can be achieved in the best possible way in this case.

The longitudinal extension of the web-shaped region can be oriented at an angle between 45° and 135°, preferably at an angle between 70° and 110° and particularly preferably at an angle between 90° and 100°. An angle of less than 90° represents an undercut, which can only be produced with considerable effort. The best possible flanging is achieved at an angle of 90°, while the mechanical stability of the flanging deteriorates as the angle increases.

Particularly with small bending radii, a clearance may form on an inner edge between the sleeve-shaped main body and the web-shaped region. Only the formation of such a clearance allows the web-shaped region to be bent or flanged with small bending radii.

In a preferred development of the support sleeve, the web-shaped region can be formed circumferentially, i.e., over an angle range of 360°. In particular, a circumferential flange promotes a centered or symmetrical arrangement of the individual electrical lines relative to the longitudinal axis of the support sleeve, i.e., relative to the center axis of the support sleeve, within the support sleeve.

In an alternative, preferred development of the support sleeve, the web-shaped region can be exposed in inner sheath portions of the sleeve-shaped main body in such a way that the respective inner sheath portion is connected to an outer sheath portion of an adjacent electrical line of the electrical line pairs. The web-shaped region tapers off and merges into the inner sheath surface of the sleeve-shaped main body. In this way, the electrical lines, which are connected to the inner sheath portions of the sleeve-shaped main body in the vicinity of the web-shaped regions, are guided along the entire length of the support sleeve on the inner sheath of the support sleeve and are thus guided in a more stable manner overall.

In order to prevent the individual electrical wires, which are intertwined or woven together in the shield, from being cut or broken off on the sharp inner edges of the web-shaped regions of the support sleeve when fixing the support sleeve to the shield and/or when crimping the outer conductor contact element to the shield, a chamfer or edge break may preferably be formed on the inner and/or outer edge of the web-shaped regions of the support sleeve.

In a further preferred embodiment of a support sleeve according to the invention, at least one pointed or sharp-edged projection may be formed on an inner wall or a boundary of the feedthrough. Such a pointed or sharp-edged projection may be formed in particular in regions of the boundary of the feedthrough in which direct contact between the pointed or sharp-edged projection and an electrical line of the electrical line pairs is excluded. This is particularly the case in regions of the inner wall of the feedthrough which are formed in a planar manner.

In this way, in the case of a single electrical line pair, a “spectacle-shaped profile” or an “eight-shaped profile” can result for the feedthrough, and in the case of two electrical line pairs, a “four-leaf clover profile” can result for the feedthrough. The pointed or sharp-edged projection on the inner wall of the feedthrough can preferably penetrate the adjacent shield of the electrical cable and thus advantageously effect additional fixation of the support sleeve on the cable via the shield.

The invention also relates to a pre-assembled cable according to the invention, preferably a pre-assembled electrical cable, which has at least one line, a shield surrounding the at least one line, and a cable sheath surrounding the shield. The shield is exposed from the cable sheath in an axial end region of the pre-assembled cable. A support sleeve according to the invention is fixed to the exposed shield and/or the cable sheath. An axial end region of the shield is folded back around the support sleeve.

Advantageously, a support sleeve can be provided for a pre-assembled cable in which the individual electrical lines of the cable are fixed and aligned in the best possible way and, at the same time, the support sleeve can be manufactured in a low-cost and therefore inexpensive manner.

The technical features, technical effects, and technical advantages mentioned above and below in relation to the support sleeve apply equally to the pre-assembled cable and vice versa.

Lastly, the invention also relates to a plug connector assembly according to the invention, preferably an electrical plug connector assembly, which has a pre-assembled cable according to the invention and a plug connector connected to the pre-assembled cable according to the invention. The plug connector has an outer conductor contact element which is pressed, preferably crimped, onto the axial end region of the shielding which is placed on the support sleeve according to the invention.

The technical features, technical effects, and technical advantages mentioned above and below in relation to the support sleeve and the pre-assembled cable apply equally to the plug connector assembly and vice versa.

The above embodiments and developments can be combined with each other as desired, where appropriate. Further possible embodiments, developments, and implementations of the invention also include combinations of features of the invention described previously or below with regard to the embodiments that are not explicitly mentioned. In particular, the skilled person will also add individual aspects as improvements or additions to the respective basic form of the present invention.

### DRAWINGS

The present invention is explained in more detail below with reference to the exemplary embodiments shown in the schematic figures of the drawing, in which:

FIGS. 1A, 1B show an isometric view and a front view of a first exemplary embodiment of a support sleeve according to the invention,

FIGS. 1C, 1D show an isometric view and a front view of a second exemplary embodiment of a support sleeve according to the invention,

FIGS. 1E, 1F show an isometric view and a front view of a third exemplary embodiment of a support sleeve according to the invention,

FIGS. 1G, 1H show an isometric view of a fourth and fifth exemplary embodiment of a support sleeve according to the invention,

FIGS. 1I, 1J show an isometric representation of a sixth and seventh exemplary embodiment of a support sleeve according to the invention,

FIGS. 2A, 2B show an isometric representation of a pre-assembled cable according to the invention with the sixth and fifth exemplary embodiments of a support sleeve according to the invention,

FIGS. 3A, 3B show two longitudinal sectional views of a support sleeve according to the invention,

FIGS. 4A, 4B show longitudinal sectional views of a pre-assembled cable according to the invention with two embodiments of a support sleeve according to the invention,

FIG. 5 shows a longitudinal sectional view of a plug connector according to the invention, and

FIGS. 6A, 6B, 6C show isometric views of a support sleeve according to the invention in the manufacturing process.

The accompanying figures of the drawing are intended to provide a further understanding of the embodiments of the invention. They illustrate embodiments and serve in conjunction with the description to explain principles and concepts of the invention. Other embodiments and many of the advantages mentioned result from the drawings. The elements of the drawings are not necessarily shown to scale in relation to each other.

In the figures of the drawing, identical elements, features, and components with the same function and effect are each assigned the same reference signs, unless otherwise specified.

The figures show preferred exemplary embodiments in which individual features of the present invention are shown in combination with each other. Features of an exemplary embodiment can also be implemented separately from the other features of the same exemplary embodiment and can therefore be easily combined by a person skilled in the art to form further useful combinations and sub-combinations with features of other exemplary embodiments.

The figures are described below in a coherent and comprehensive manner.

### DETAILED DESCRIPTION OF THE INVENTION

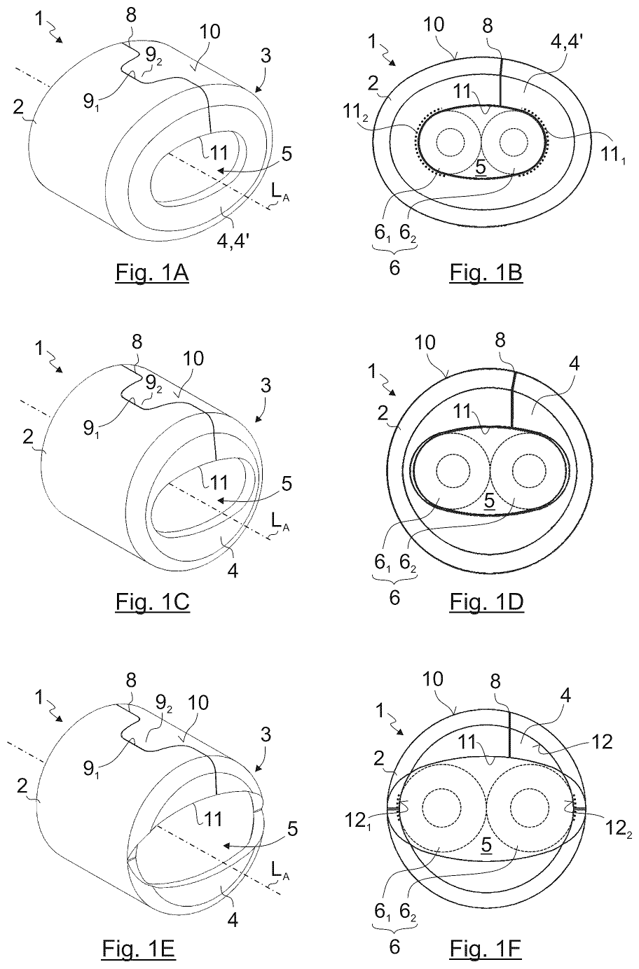

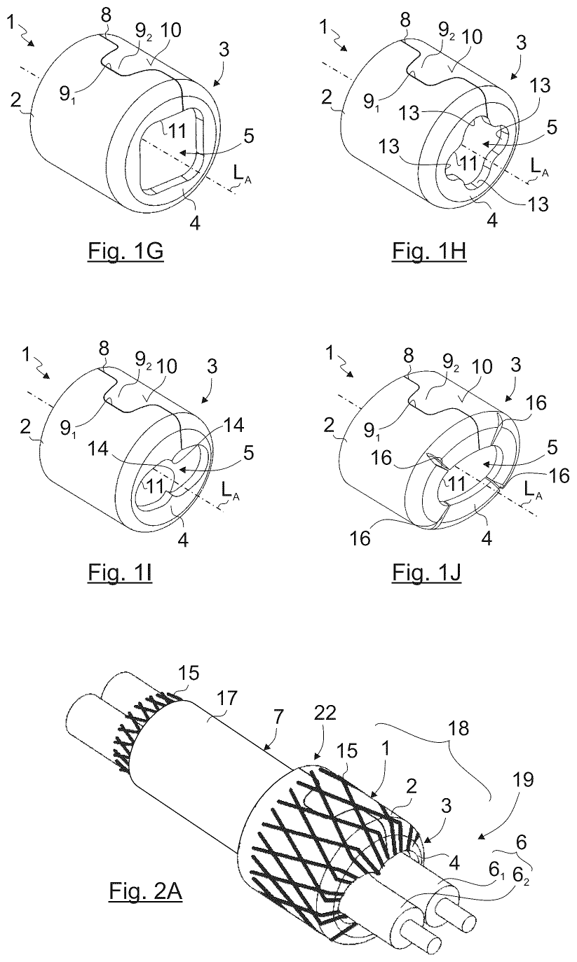

Various exemplary embodiments of a support sleeve according to the invention are explained below with reference to FIGS. 1A-1J:

In all exemplary embodiments, the support sleeve 1 according to the invention has a sleeve-shaped main body 2 and, at at least one axial end of the sleeve-shaped main body 2, preferably at a plug-side axial end 3 of the sleeve-shaped main body 2, a web-shaped region 4. The sleeve-shaped main body 2 and the at least one web-shaped region 4 are preferably formed in one piece, as shown in FIGS. 1A-1J. The web-shaped region 4 has a feedthrough 5 through which electrical lines 61 and 62 of at least one electrical line pair 6 of an electrical cable 7 (see FIGS. 2A and 2B) are passed through and fixed. Due to the shape of the feedthrough 5, the individual electrical lines 61 and 62 of each electrical line pair 6 are aligned in a respective associated plane. The individual lines 61 and 62 of each electrical line pair 6 are each designed as usual as an insulated conductor, i.e., as an electrical conductor surrounded by insulation.

The support sleeve 1 is preferably designed as a stamped-and-bent component and thus has a longitudinal slot 8 in the direction of the longitudinal axis LA of the support sleeve 1. For the mechanical stabilization of a support sleeve 1 designed as a stamped-bent component, a recess 91 may be formed on one side edge of the main body 2, in which an elevation 92 formed correspondingly on the other side edge of the main body 2 is fixed. The web-shaped region 4 of the support sleeve 1 is preferably designed as a flange 4′.

In a first exemplary embodiment of the support sleeve 1 according to the invention as shown in FIGS. 1A and 1B, the outer profile of the support sleeve 1, i.e., the cross-sectional profile of the outer sheath 10 of the support sleeve 1, as well as the inner profile of the feedthrough 5, i.e., the cross-sectional profile of the inner sheath of the web-shaped region 4 or the boundary 11 of the feedthrough 5, are each elliptically shaped. As can be seen in particular from the front view of the support sleeve 1 in FIG. 1B, the boundary 11 of the feedthrough 5 has regions which each follow a portion of the surface contour of an adjacent electrical line 61 and 62 of the electrical line pair 6.

FIG. 1B shows that the dotted semi-cylindrical regions 111 and 112 of the boundary 11 of the feedthrough 5 follow the semi-cylindrical portions of the surface contour of the respective adjacent electrical lines 61 and 62.

In a second embodiment of the support sleeve 1 according to the invention, as shown in FIGS. 1C and 1D, the cross-sectional profile of the outer sheath 10 of the support sleeve 1 is round, while the cross-sectional profile of the boundary 11 of the feedthrough 5 is elliptical, as in the first embodiment of the support sleeve 1 according to the invention.

Equivalently to the second embodiment of the support sleeve 1 according to the invention, in a third embodiment of the support sleeve 1 according to the invention as shown in FIGS. 1E and 1F, the cross-sectional profile of the outer sheath 10 of the support sleeve 1 is round and the cross-sectional profile of the boundary 11 of the feedthrough 5 is elliptical. In contrast to the second embodiment, in the third embodiment, the feedthrough 5 of the web-shaped region 4 of the support sleeve 1 is suspended in the dashed-line inner sheath portions 121 and 122 of the inner sheath 12 of the sleeve-shaped main body 2 of the support sleeve 1. The web-shaped region 4 merges into the inner sheath portions 121 and 122 of the sleeve-shaped main body 2 in such a way that the outer sheath portion of an adjacent electrical line 61 or 62 is not guided by the web-shaped region 4, but by associated inner sheath portions 121 and 122 respectively. In addition, as can also be seen from FIG. 1F, the electrical lines 61 and 62 can rest against regions of the boundary 11 of the feedthrough 5 in the web-shaped region 4 of the support sleeve 1.

FIG. 1G shows a fourth exemplary embodiment of the support sleeve 1 according to the invention with a feedthrough 5 in the web-shaped region 4, which is suitable for fixing and guiding two electrical line pairs 6. The inner profile of the feedthrough 5 is rectangular, in particular square, and has rounded corners. However, a rectangular, in particular square, inner profile with non-rounded corners is also conceivable. The four side surfaces of the rectangular or square inner profile of the feedthrough 5 are designed in such a way that they each contact one electrical line or two adjacent electrical lines at least linearly and thus guide and fix them.

A support sleeve 1, which is also suitable for guiding and fixing two electrical line pairs 6, is shown in a fifth exemplary embodiment of the support sleeve 1 according to the invention in FIG. 1H. The inner profile of the feedthrough 5 in the web-shaped region 4 of the support sleeve 1 is shaped like a cloverleaf and has bulges 13, in each of which one electrical line of the two electrical line pairs 6 is guided and fixed.

In a sixth exemplary embodiment of the support sleeve 1 according to the invention, shown in FIG. 1I, sharp-edged projections 14 are formed in the elliptically shaped inner profile of the feedthrough 5, which can penetrate a shield 15 of the cable 7 (see FIGS. 2A and 2B) when the support sleeve 1 is mounted on the cable 7, thereby improving the fixation of the support sleeve 1 on the cable 7. The sharp-edged projections 14 are preferably formed in regions of the boundary 11 of the feedthrough 5 in which direct contact between the sharp-edged projections 14 and the electrical lines 61 and 62 of the electrical line pairs 6 is excluded.

In the seventh exemplary embodiment of the support sleeve 1 according to the invention shown in FIG. 1J, the web-shaped region 4 of the support sleeve 1 is provided with multiple slits. Ideally, each individual slit 16 is closed when the support sleeve 1 is installed. In order to avoid disruptive bulges or material protrusions in the web-shaped region 4 of the support sleeve 1 during the bending method step, the web-shaped region 4 of the support sleeve 1 is divided into individual segments by the slits 16.

FIG. 2A shows a pre-assembled electrical cable 7 consisting of a single electrical line pair 6 with two electrical lines 61 and 62 for transmitting a single differential signal. FIG. 2B shows a pre-assembled electrical cable consisting of two electrical line pairs 6, each with two electrical lines 61 and 62 in a star-four arrangement for transmitting two differential signals.

The electrical lines 61 and 62 of each electrical line pair 6 are jointly enclosed by the shield 15. The shield 15 is in turn enclosed by a cable sheath 17. In an axial end region 18 of the electrical cable 7, the shield 15 is exposed from the cable sheath. The support sleeve 1 is fixed to the shield 15 exposed from the cable sheath 17. Alternatively, the support sleeve 1 can also be fixed to the cable sheath 17. The shield 15 is folded back around the support sleeve 1 so that the electrical lines 61 and 62 of each electrical line pair 6 are exposed at the axial end 19 of the electrical cable 7.

The web-shaped region 4 of the support sleeve 1 can be oriented at a specific angle relative to the longitudinal extension of the support sleeve 1:

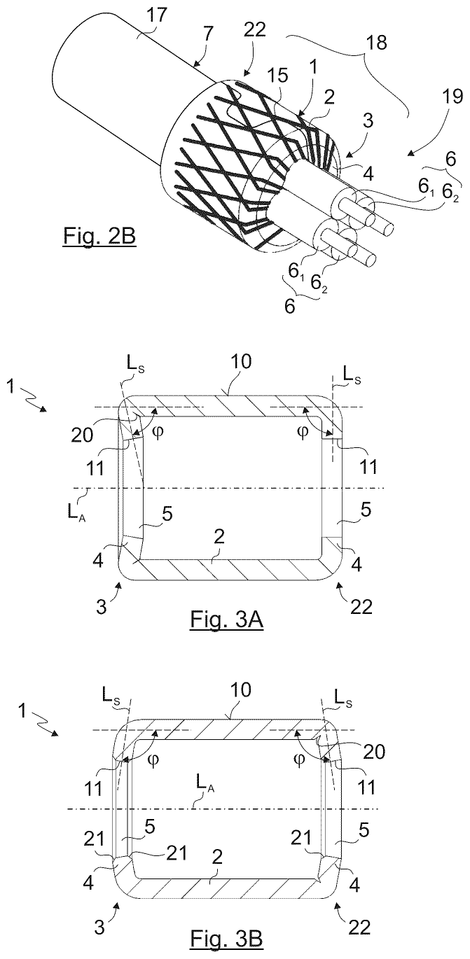

The longitudinal extension L_{S} of the web-shaped region 4 of the support sleeve 1 can be oriented at an angle φ of 90° to the longitudinal axis L_{A} of the support sleeve 1 (web-shaped region 4 of the support sleeve 1 shown in FIG. 3A on the right-hand side, i.e. at the cable-side axial end 22 of the support sleeve 1), at an angle φ smaller than 90° to the longitudinal axis L_{A} of the support sleeve 1 (web-shaped region 4 of the support sleeve 1 shown in FIG. 3A on the left side, i.e. at the axial end 3 of the support sleeve 1 on the plug-in side) or at an angle φ greater than 90° to the longitudinal axis L_{A} of the support sleeve 1 (web-shaped region 4 of the support sleeve 1 shown in FIG. 3B on the left side, i.e. at the axial end 3 of the support sleeve 1 on the plug-in side).

In the case of small bending radii, a relief cut 20 is preferably formed on the inner edge between the sleeve-shaped main body 2 and the web-shaped region 4 of the support sleeve 1 (shown in FIG. 3B on the right-hand side, i.e. on the cable-side axial end 22 of the support sleeve 1, the web-shaped region 4 of the support sleeve 1 shown in FIG. 3B, and in FIG. 3A on the left side, i.e., on the axial end 3 of the support sleeve 1 on the plug-in side, of the support sleeve 1) in order to achieve a purposeful flanging of the web-shaped region 4.

FIG. 3B also shows that a chamfer 21 is formed on the inside and outside of the inner sheath or the boundary 11 of the feedthrough 5 in order to prevent the electrical lines 6₁ and 6₂ of each line pair 6 from being cut or broken during the crimping process.

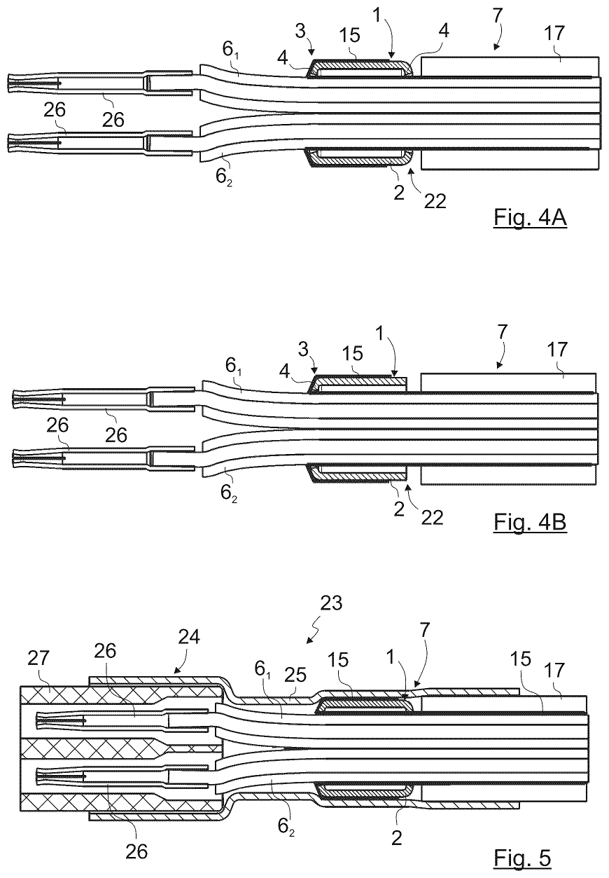

FIG. 4A shows a pre-assembled electrical cable 7 in which a first embodiment of a support sleeve 1 according to the invention with a web-shaped region 4 at the plug-side axial end 3 and with a web-shaped region 4 at the cable-side axial end 22 is fixed to the shield 15. In an electrical cable 7 with stranded electrical lines 61 and 62 of at least one electrical line pair 6, the inner profile of the feedthrough 5 in the web-shaped region 4 at the cable-side axial end 22 of the support sleeve 1 is preferably round in order to accommodate electrical lines 6₁ and 6₂ of at least one electrical line pair 6 in any orientation relative to the longitudinal axis L_{A} of the support sleeve 1 through the web-shaped region 4 of the support sleeve 1 formed at the cable-side axial end 22.

In the pre-assembled electrical cable 7 of FIG. 4B, a second embodiment of a support sleeve 1 according to the invention is fixed to the shield 15 solely by a web-shaped region 4 at the plug-side axial end 3. In order to guide the electrical lines 6₁ and 6₂ of at least one electrical line pair 6 into the support sleeve 1 in any orientation relative to the longitudinal axis L_{A} of the support sleeve 1, the sleeve-shaped main body 2 in the second embodiment of the support sleeve 1 according to the invention preferably has a round inner or outer profile.

FIG. 5 shows an electrical plug connector assembly 23 according to the invention, which comprises an electrical plug connector 24 and a pre-assembled electrical cable 7 that is electrically and mechanically connected to the electrical plug connector 24. The shield 15 wrapped around the support sleeve 1 according to the invention is electrically and mechanically connected to an outer conductor contact element 25 of the electrical plug connector 24 via a crimp connection in the region of the support sleeve 1. The two electrical lines 6₁ and 6₂ of the electrical line pair 6 are each electrically and mechanically connected to an inner conductor contact element 26 of the electrical plug connector 24, preferably via a crimp connection. The two inner conductor contact elements 26 are electrically insulated from the outer conductor contact element 25 via an insulator element 27 of the electrical plug connector 24.

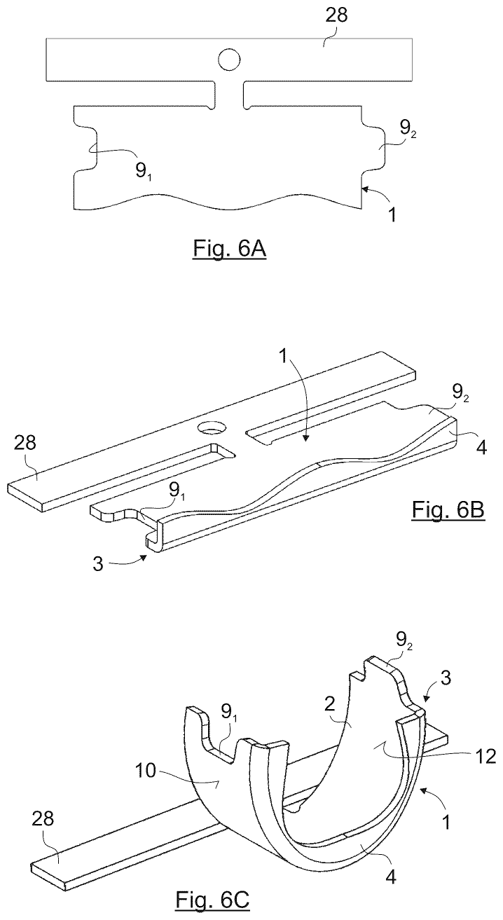

FIGS. 6A-6C show the individual method steps in the manufacture of the support sleeve 1 according to the invention:

In a first method step according to FIG. 6A, a planar blank of the support sleeve 1 according to the invention is produced by means of a punching process. The planar blank of the support sleeve 1 according to the invention is attached to a carrier strip 28.

In a second method step according to FIG. 6B, at least one web-shaped region 4 of the support sleeve 1 according to the invention is produced by means of a bending process, in particular a flanging process.

In a third method step according to FIG. 6C, the main body 2 of the support sleeve 1 according to the invention is bent into a sleeve shape by means of a further bending process.

In a first embodiment of a manufacturing process, the main body 2 of the support sleeve 1 can be bent completely into a sleeve shape and the pre-assembled electrical cable 7 can be inserted axially into the sleeve-shaped support sleeve 1. In a second embodiment of a manufacturing process, the main body 2 of the support sleeve 1 can be bent into a U-shape in a first bending step, the pre-assembled electrical cable 7 can be inserted laterally into the U-shaped support sleeve 1, and the main body 2 of the support sleeve 1 can be bent completely into a sleeve shape.

Although the present invention has been described in full above on the basis of preferred embodiments, it is not limited thereto, but may be modified in a variety of ways.

1. A support sleeve, for guiding and fixing at least one line, comprising:
a main body in a form of a sleeve around a longitudinal axis (L_{A}),
wherein the main body includes at least one axial end;
a web-shaped region located at the at least one axial end of the main body and directed towards the longitudinal axis (L_{A}) with a feedthrough, such that each of the at least one line is held in the feedthrough without movement.

2. The support sleeve of claim 1,
wherein a boundary of the feedthrough includes a region which is shaped so as to follow at least one portion of a surface contour of an adjacent line of the at least one line.

3. The support sleeve of claim 1,
wherein the feedthrough includes a plurality of side surfaces and has a rectangular profile, and
wherein each side surface of the plurality of side surfaces is designed to at least linearly contact an adjacent line of the at least one line.

4. The support sleeve of claim 1,
wherein the main body is designed as a stamped-and-bent part.

5. The support sleeve of claim 1,
wherein the web-shaped region is configured as a flange.

6. The support sleeve of claim 1,
wherein the web-shaped region includes at least one slot.

7. The support sleeve of claim 1,
wherein a cross-section of an outer sheath of the support sleeve is elliptically shaped along a longitudinal extension of the main body.

8. The support sleeve of claim 1,
wherein a cross-section of an outer sheath of the support sleeve is circularly shaped along a longitudinal extension of the main body.

9. The support sleeve of claim 1,
wherein a longitudinal extension of the web-shaped region is oriented at an angle between 45° and 135° relative to the longitudinal axis (L_{A}).

10. The support sleeve of claim 1,
further comprising a relief cut on an inner edge between the main body and the web-shaped region.

11. The support sleeve of claim 1,
wherein the web-shaped region is formed around a circumference.

12. The support sleeve of claim 1,
wherein the web-shaped region) is exposed in at least one inner sheath portion of the main body in such a way that each respective inner sheath portion is connected to a corresponding outer sheath portion of an associated line of the at least one line.

13. The support sleeve of claim 1,
wherein a boundary of the feedthrough includes at least one pointed projection or sharp-edged projection.

14. A pre-assembled cable comprising:
at least one line;
a shield surrounding the at least one line;
a cable sheath surrounding the shield,
wherein the shield is exposed from the cable sheath in an axial end region of the pre-assembled cable; and
a support sleeve including:
(a) a main body in a form of a sleeve around a longitudinal axis (L_{A} ), wherein the main body includes at least one axial end; and
(b) a web-shaped region located at the at least one axial end of the main body and directed towards the longitudinal axis (L_{A} ) with a feedthrough, such that each of the at least one line is held in the feedthrough without movement;
wherein the support sleeve is at least one of (i) fixed to the exposed shield and (ii) fixed on the cable sheath; and
wherein an axial end region of the shield is folded back around the support sleeve.

15. A plug connector assembly comprising:
a pre-assembled cable including:
(i) at least one line;
(ii) a shield surrounding the at least one line;
(iii) a cable sheath surrounding the shield, wherein the shield is exposed from the cable sheath in an axial end region of the pre-assembled cable; and
(iv) a support sleeve including:
(a) a main body in a form of a sleeve around a longitudinal axis (L_{A} ), wherein the main body includes at least one axial end; and
(b) a web-shaped region located at the at least one axial end of the main body and directed towards the longitudinal axis (L_{A} ) with a feedthrough, such that each of the at least one line is held in the feedthrough without movement;
wherein the support sleeve is at least one of (i) fixed to the exposed shield and (ii) fixed on the cable sheath, and
wherein an axial end region of the shield is folded back around the support sleeve; and
a plug connector connected to the pre-assembled cable, wherein the plug connector has an outer conductor contact element which is pressed onto the axial end region of the shield folded back on the support sleeve.

16. The pug connector assembly of claim 15, wherein the pressed conductor contact element is crimped onto the axial end region of the shield folded back on the support sleeve.

17. The support sleeve of claim 1, wherein the at least one line is an electrical line.

18. The support sleeve of claim 9, wherein the longitudinal extension of the web-shaped region is oriented at an angle between 70° and 110° relative to the longitudinal axis (L_{A}).

19. The support sleeve of claim 9, wherein the longitudinal extension of the web-shaped region is oriented at an angle between 90° and 100° relative to the longitudinal axis (L_{A}).

20. The pre-assembled cable of claim 14, wherein a boundary of the feedthrough includes a region which is shaped so as to follow at least one portion of a surface contour of an adjacent line of the at least one line.
